(19) United States
(12) Patent Application Publication
(10) Pub. No.: US 2024/0006685 A1
(43) Pub. Date: Jan. 4, 2024

(54) TEMPERATURE CONTROL DEVICE, IN PARTICULAR A COOLING DEVICE FOR A MOTOR VEHICLE

(71) Applicant: VALEO SYSTEMES THERMIQUES, La Verriere (FR)

(72) Inventors: Thibaut PERRIN, La Verriere (FR); Stephane TONDELLI, La Verriere (FR); Jianqi SUN, Shashi (CN)

(73) Assignee: VALEO SYSTEMES THERMIQUES, La Verriere (FR)

(21) Appl. No.: 18/251,601

(22) PCT Filed: Oct. 21, 2021
(86) PCT No.: PCT/EP2021/079222

§ 371 Date: May 3, 2023

(30) Foreign Application Priority Data
Nov. 4, 2020 (FR) 2011331

(51) Int. Cl. H01M 10/6568; F28F 3/12; H01M 10/613; H01M 10/625

(52) U.S. Cl. CPC H01M 10/6568; F28F 3/12; H01M 10/613; H01M 10/625; F28F 2210/02; F28F 2225/04; H01M 2220/20

(57) ABSTRACT

A temperature regulation device for cooling an electrical component liable to give off heat during operation, including: an upper plate and a lower plate joined together to form a plurality of circulation channels for a heat transfer fluid; a fluid inlet zone and a fluid outlet zone; the plurality of fluid circulation channels including: at least two groups of pass channels each forming a fluid pass in a thermally operative region; at least one inlet channel, connecting the fluid inlet zone and one of the at least two groups of pass channels, at least two outlet channels, connecting another one of the at least two groups of pass channels to the fluid outlet zone, with pass channels being subdivided into as many subgroups as there are outlet channels, each subgroup of pass channels being connected to the respective outlet channel.

### TECHNICAL FIELD

The present invention relates to a temperature regulation device, notably for cooling, notably for an electrical component liable to give off heat during operation, notably to a device for cooling at least one battery or battery cells of a motor vehicle.

### BACKGROUND OF THE INVENTION

Vehicle batteries, in particular for electric vehicles or hybrid vehicles, should as much as possible be maintained at the desired temperature, which is why use is made of devices referred to as cooling devices for vehicle batteries. These cooling devices comprise cooling plates through which a cooling liquid circulates. The cooling plates are installed, as far as possible without gaps, on the outer side of the batteries in order to dissipate heat or else to heat the battery. Cooling devices in which the cooling plate is made up of two plate parts that are normally fixed directly to one another are known. In this case, the first plate part is preferably flat, and the second plate part is preferably a stamped or deformed metal sheet that has meandering depressions. Said depressions are closed by the flat plate part, which is fixed to the stamped plate part, such that refrigerant ducts are formed. Patent EP 2 828 922 B1 describes such a device.

### SUMMARY OF THE INVENTION

The invention aims to improve this type of device.

The invention thus proposes a temperature regulation device, notably for cooling, for an electrical component liable to give off heat during operation, notably for an electrical energy storage module, this device having an upper plate and a lower plate joined to the top plate such that the plates together form a plurality of circulation channels for a heat transfer fluid, notably a refrigerant fluid, notably a fluid selected from the following refrigerant fluids R134a, R1234yf and R744, in which device at least some of the channels lead into at least one diverting chamber, by virtue of which the fluid can make a diversion, in which device at least one of the diverting chamber and the channels has a mechanical reinforcing element formed on a wall of this diverting chamber or of one of the channels, this reinforcing element being designed to improve the mechanical resistance of the chamber and/or of the channel to potential deformations under the action of high pressure.

In this type of device, there are concentrations of stresses in the zones in which the fluid must make diversions or reversals or take branching paths, for example nonlinear ones, notably in the zones in which the flow of fluid is distributed, collected or reversed. To avoid deformation in these zones, use is made of particular shapes, preferably obtained by stamping, these being the one or more reinforcing elements according to the invention.

According to one aspect of the invention, the reinforcing element extends over the entire height of the diverting chamber and of the channels.

According to one aspect of the invention, the diverting chamber and the channels each have a length measured in a direction of flow of the fluid, and the reinforcing element extends only over part of the length respectively of the diverting chamber and the channel, notably less than half of this length, or less than one quarter or one tenth of this length.

In other words, the reinforcing element is relatively small in relation to the diverting chamber or the channels as a whole.

According to one aspect of the invention, a plurality of reinforcing elements are provided along the diverting chamber and/or one of the channels, this plurality of reinforcing elements being, for example, evenly spaced apart from one another.

According to one aspect of the invention, these reinforcing elements formed on the diverting chamber are all identical.

According to one aspect of the invention, the reinforcing element has a rounded profile when viewed in a direction perpendicular to the plates, this rounded profile having a concavity directed toward the outside of the diverting chamber or of the associated channel.

According to one aspect of the invention, the concavity has a radius of curvature, notably with a value less than 5 mm, notably less than 2 mm.

According to one aspect of the invention, two neighboring channels are connected to the diverting chamber in connecting sections such that a gap between channels is present in the diverting chamber between the two connecting sections and the reinforcing element is located in this gap between channels, notably in the middle of this gap between channels.

According to one aspect of the invention, the reinforcing elements are disposed evenly spaced apart along a line running along the diverting chamber.

According to one aspect of the invention, the fluid passage cross section of the diverting chamber is increased on either side of each reinforcing element.

According to one aspect of the invention, two neighboring fluid channels are connected to the diverting chamber, and the reinforcing element formed on a lateral wall of the diverting chamber, facing these two fluid channels, is disposed so as to be able to position an inscribed imaginary circle adjacent to the two neighboring channels and the reinforcing element facing them, this inscribed circle having a diameter notably less than 15 mm.

According to one aspect of the invention, the one or more reinforcing elements are formed by stamping.

The reinforcing element is preferably positioned in a joining zone where one channel joins another channel or a diverting chamber, this reinforcing element notably facing this channel.

Notably, when a number N of consecutive channels is connected to a diverting chamber, a number M of consecutive reinforcing elements is provided, with M=N or M being less than N.

According to one aspect of the invention, the reinforcing elements are disposed along a straight line, notably equidistantly from one another.

According to one aspect of the invention, the reinforcing elements make it possible to have larger fluid passage cross sections whilst still ensuring good mechanical resistance to deformation. This increase in the refrigerant fluid passage cross section is accompanied by a decrease in the resulting pressure drop. The increase in passage cross section can be approximately +40% in relation to a conventional design without a reinforcing element.

The invention also makes it possible to improve the shape coefficient.

According to one aspect of the invention, the diverting chamber can be designed to make it possible to reverse the flow of fluid, or to make it possible to collect fluid at the fluid inlet or outlet. In the latter case, the diverting chamber can be referred to as fluid inlet or outlet collection chamber.

Another subject of the invention, independently or in combination with the preceding one, is a temperature regulation device, notably for cooling, for an electrical component liable to give off heat during operation, notably for an electrical energy storage module, this device having an upper plate and a lower plate joined to the top plate such that the plates together form a plurality of circulation channels for a heat transfer fluid, notably a refrigerant fluid, notably a fluid selected from the following refrigerant fluids R134a, R1234yf and R744, which device comprises a fluid inlet zone and a fluid outlet zone, these inlet and outlet zones notably being located in a thermally inoperative region, which is a zone that does not face the one or more components to be cooled, the plurality of fluid circulation channels comprising at least two groups of pass channels each forming a fluid pass in a thermally operative region, which is a zone located facing the one or more components to be cooled, these channels notably all having the same fluid passage cross section over the majority of their length, the plurality of channels moreover comprising at least one inlet channel, connecting the inlet zone and one of the groups of pass channels, and at least one outlet channel, notably at least two outlet channels, connecting one of the groups of pass channels to the fluid outlet zone, the pass channels of this group being subdivided into as many subgroups of channels as there are outlet channels, each subgroup of pass channels joining the outlet channel associated with it.

By virtue of the invention, the number of channels and their distribution into subgroups can vary depending on requirements. It is important that the number of channels in the last pass is high enough to ensure good thermal homogeneity.

In addition, a high number of channels makes it possible for them to have a relatively small passage cross section, thus limiting the pressure drops.

The invention also makes it possible to have standard channels and the thermal needs are met by varying the number of them and the pattern in which they are laid out.

Notably, the invention is based on the way in which the channels are distributed at the start of a pass, and the way in which the channels converge at the end of a pass.

The invention advantageously makes it possible to balance the flow rates of fluid in the channels, and consequently to homogenize the temperature of the plate.

According to one aspect of the invention, the channels of a pass define a branched layout at the start and at the end of the pass.

For example, two channels can be joined at a node to form a common channel, and the common channel joins another common channel coming from a node at which two or more other channels join.

According to one aspect of the invention, the numbers of channels in the subgroups are different.

According to one aspect of the invention, the pass group directly connected to the inlet channel is adjacent to one of the subgroups of the pass group connected to the one or more outlet channels, this subgroup having the highest number of channels among the other subgroups of this group connected to the one or more outlet channels.

According to one aspect of the invention, the group of channels connected to the one or more outlet channels is subdivided into at least three subgroups, the number of channels in the outer subgroups is higher than the number of channels of the subgroup in between the two outer subgroups.

According to one aspect of the invention, the number of channels of the outer subgroups comprises one more than the number of channels of the subgroup in between them, for example the number of channels of the outer subgroups is 5 and the number of channels of the subgroup in between them is 4.

In another example, the number of channels of the outer subgroups is 4, and the number of channels of the subgroup in between them is 3.

According to one aspect of the invention, the numbers of channels in the outer subgroups are different from one another, for example one of the outer subgroups has 3 channels and the other outer subgroup has 5 channels.

For example, one of the outer subgroups has 5 channels and the other one has 4 channels.

According to one aspect of the invention, the group of channels connected to the inlet channel has more than 2 channels, notably more than 4 channels, or even at least 6 channels.

According to one aspect of the invention, the number of outlet channels is two, and the number of subgroups associated with these outlet channels is also two.

According to one aspect of the invention, the channels in each group are mutually parallel over the majority of their length.

According to one aspect of the invention, these channels are substantially rectilinear over the majority of their length.

According to one aspect of the invention, the number of inlet channels is smaller than the number of outlet channels, for example the number of inlet channels is one and the number of outlet channels is two or more.

According to one aspect of the invention, the groups of pass channels have numbers of channels which differ from one pass to the next. Notably, this number increases, or remains stable, from one pass to the next, in the direction from the fluid inlet to the fluid outlet. In other words, the groups of pass channels have numbers of channels which differ from one pass to another, notably this number of channels increases with each pass as flow occurs.

According to one aspect of the invention, in at least one of the passes, the channels of this pass are disposed in a branching organization with nodes where at least two channels of the pass are connected either, in the case of a distribution node, to distribute the fluid from one channel into two or more channels, or, for a collection node, to collect the fluid from two or more channels into a collection channel, these nodes being disposed so as to make it possible to balance the pressure.

According to one aspect of the invention, in the pass in question, the total number of distribution nodes and collection nodes is the same for all the channels of the pass.

According to one aspect of the invention, in the pass in question, the total number of distribution nodes and collection nodes varies in accordance with the channels of the pass by at most one channel, or even at most two channels.

According to one aspect of the invention, the pass has a branched organization with two distribution nodes and two collection nodes, and one of the channels first of all splits off from the collective channel via the distribution node, leaving the other two channels to be distributed further downstream via the distribution node; downstream of the distribution node, this channel joins the channel via the collection node, which is upstream of the other collection node, which node collects the already-together channels with the channel.

When a channel is split off first in the distribution zone, for example the channel 81, it should then rejoin last in the collection zone.

In this way, the invention makes it possible to balance the pressure losses and thus to homogenize the flow rates.

According to one aspect of the invention, for a predefined pass, in the zone for distributing the flow, the flow is divided into two channels after the distribution node. Then, these two channels are themselves divided into two, at the distribution nodes, respectively to supply other channels following one of these distribution nodes, and the channels following the node. In the collection zone, the nodes are symmetrical to those in the distribution zone. As a result, the channels converge in one channel via the collection node, and the other channels converge in a second channel via the other collection node. Then, these two channels join at the node.

According to one aspect of the invention, the number of inlet channels is comprised between 1 and 2.

According to one aspect of the invention, the number of outlet channels is comprised between 2 and 6.

For example, 2 inlet channels and 4 outlet channels can be provided.

As another example, 2 inlet channels and 5 or 6 outlet channels can be provided.

Another subject of the invention is a system having an electrical component liable to give off heat during operation, notably for an electrical energy storage module, and a cooling device described above that is designed to cool the component, this component or battery being in thermal contact with the upper plate of the cooling device.

### BRIEF DESCRIPTION OF DRAWINGS

Further features and advantages of the invention will become more clearly apparent from reading the following description, which is given by way of illustrative and nonlimiting example, and the appended drawings, in which:

FIG. 1 schematically and partially illustrates a temperature regulation device;

FIG. 2 schematically and partially illustrates the temperature regulation device of FIG. 1 in a different view;

FIG. 3 schematically and partially illustrates a temperature regulation device according to another example of the invention, with details regarding part of the plates;

FIG. 4 schematically and partially illustrates temperature regulation device according to another example of the invention;

FIG. 5 schematically and partially illustrates the temperature regulation device of FIG. 4 with arrows showing the fluid passes;

FIG. 6 schematically and partially illustrates a temperature regulation device according to another example of the invention;

FIG. 7 schematically and partially illustrates a temperature regulation device according to another example of the invention;

FIG. 8 schematically and partially illustrates a temperature regulation device according to another example of the invention; and

FIG. 9 schematically and partially illustrates a temperature regulation device according to another example of the invention.

### DETAILED DESCRIPTION OF THE INVENTION

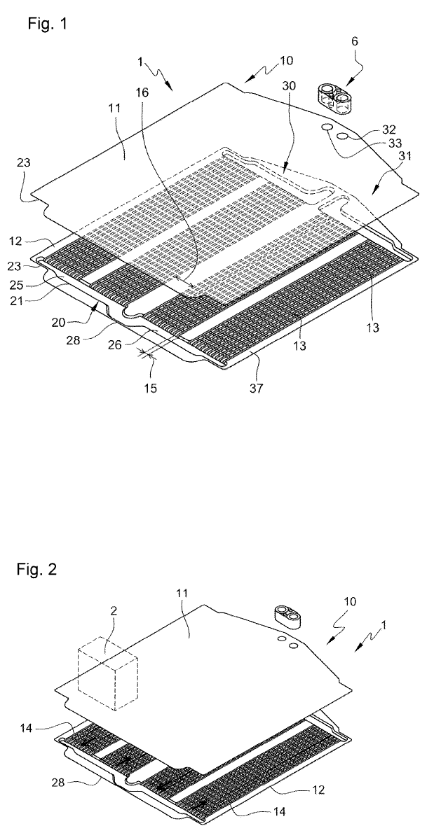

FIG. 1 and FIG. 2 depict a system 1 having a set of battery cells 2 to be cooled, for example arranged in two or more rows, and a temperature regulation device 10 designed to cool the battery cells 2, which are in thermal contact with an upper plate 11 of the cooling device 10, as explained below.

The temperature regulation device 10 has an upper plate 11, a lower plate 12 joined to the upper plate 11 such that the plates 11, 12 together form a plurality of circulation channels 13 for a heat transfer fluid, notably a refrigerant fluid, notably a fluid selected from the following refrigerant fluids: R134a, R1234yf and R744. The channels 13 are grouped into groups 14 of channels 13, the channels 13 of a group 14 extending substantially parallel to one another with a predetermined spacing between neighboring channels 13, referred to as intra-group spacing 15. The channels 13 each have a cross section comprised between 1 mm2 and 15 mm2, for example locally approximately 11 mm2 in each channel 13. The channels 13 extend substantially over the entire length of the plates 11, 12.

The plates 11, 12 are made of aluminum.

The temperature regulation device 10 has a diverting chamber 20 designed to conduct the fluid leaving one of the groups 14 of channels 13 toward one of the other groups 14 of channels 13. The diverting chamber 20 is formed by the upper plate 11 and lower plate 12, for example made of aluminum. The lower plate 12 has a stamped zone 21 designed to contribute to the formation of the diverting chamber 20. The stamped zone 21 is closed with the other of the plates 11, which is flat, to form the diverting chamber 20. The diverting chamber 20 extends over one side 23 of the plates.

The temperature regulation device 10 has an inlet zone 30 for the refrigerant fluid of the channels 13, this inlet zone being formed between the two plates 11 and 12. This fluid inlet zone 30 is designed to supply all the fluid circulation channels 13, which lead into the diverting chamber 20, specifically the channels 13 in which the fluid flows toward the diverting chamber. This inlet zone 30 is common to the groups 14 of channels 13. The temperature regulation device 10 comprises an outlet zone 31 for refrigerant fluid leaving the channels 13, this outlet zone being formed between the two plates 11 and 12. This fluid outlet zone 31 is designed to conduct the fluid leaving all the fluid circulation channels 13, which originate from the diverting chamber. This outlet zone 31 is common to the two groups of channels 13. The inlet zone 30 and outlet zone 31 are adjacent to an inlet orifice 32 and orifice outlet 33, respectively. The inlet orifice 32 and outlet orifice 33 are connected to a pipe connector block 6.

The lower plate 2 has zones 37 of rounded cross section, notably stamped zones, to form the channels 13 with the upper plate. The inlet zone 30 and outlet zone 31 include stamped zones of the lower plate 12.

With preference, the heat transfer fluid can be chosen from the refrigerant fluids with the designation R134a, R1234yf and R744.

The battery cells comprise, for example, a plurality of lithium-ion (Li-ion) batteries for use in a hybrid vehicle. In another embodiment, the plurality of battery cells are Li-ion batteries for use in a battery-powered electric vehicle. The diverting chamber 20 and/or the inlet zone 30 and/or the outlet zone 31 include(s), where appropriate, reinforcing elements to reinforce the mechanical strength in these zones, which are potentially of larger cross section.

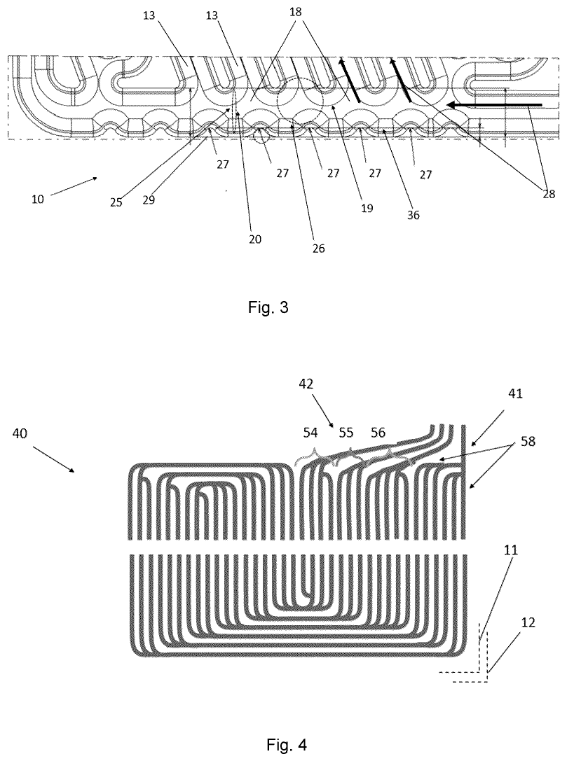

FIG. 3 depicts a detail of a temperature regulation device according to one example of the invention, which shows most of the elements of the example described above.

Here, a further description will be given of a diverting chamber and of the channels 13 connected thereto.

Channels 13 lead into a diverting chamber 20, by virtue of which the fluid can make a diversion.

The arrows 28 show the direction of flow of the fluid in the channels 13 and the diverting chamber 20.

The diverting chamber 20 has mechanical reinforcing elements 27 formed on a wall of this diverting chamber 20, each reinforcing element 27 being designed to improve the mechanical resistance of the chamber to potential deformations under the action of high pressure.

Each reinforcing element 27 extends over the entire height of the diverting chamber 20.

The diverting chamber 20 and the channels 13 each have a length measured in a direction of flow of the fluid, and each reinforcing element 27 extends only over part of the length of the diverting chamber 20, in this instance less than ⅕ or ⅛ or 1/10 of the total length of the associated diverting chamber 20.

The reinforcing elements 27 are provided along the diverting chamber 20, this plurality of reinforcing elements being evenly spaced apart from one another.

These reinforcing elements 27 formed on the diverting chamber 20 are all identical, with the same shape and the same dimensions.

Reinforcing elements with different dimensions and/or dimensions could alternatively be provided.

Each reinforcing element 27 has a rounded profile when viewed in a direction perpendicular to the plates, this rounded profile having a concavity 29 directed toward the outside of the associated diverting chamber 20.

The concavity 29 has a radius of curvature, notably with a value less than 5 mm, notably less than 2 mm. The radius of curvature is that of the dotted-line circle in FIG. 3, with a value of 1.1 mm.

Two neighboring channels 13 are connected to the diverting chamber 20 in connecting sections 18 such that a gap 19 between channels 13 is present in the diverting chamber 20 between the two connecting sections 18 and the reinforcing element 27 is located in this gap between channels 13, in this instance in the middle of this gap between channels 13.

The reinforcing elements 27 are disposed evenly spaced apart along a line 36 running along the diverting chamber 20.

The reinforcing elements 27 are formed by stamping on a corresponding plate.

The reinforcing elements 27 make it possible to have larger fluid passage cross sections whilst still ensuring good mechanical resistance to deformation. This increase in the refrigerant fluid passage cross section is accompanied by a decrease in the resulting pressure drop. The increase in passage cross section can be approximately +40% in relation to a conventional design without a reinforcing element.

Two neighboring fluid channels 13 are connected to the diverting chamber, and the reinforcing element 27 formed on a lateral wall of the diverting chamber 20, facing these two fluid channels 13, is disposed so as to be able to position an inscribed imaginary circle 26 adjacent to the two neighboring channels 13 and the reinforcing element facing them, this inscribed circle 26 having a diameter less than 15 mm.

It will be noted that the fluid passage cross section 25 of the diverting chamber 20 is increased on either side of each reinforcing element 27.

The diverting chamber 20 can be designed to make it possible to reverse the flow of fluid, or to make it possible to collect fluid at the fluid inlet or outlet. In the latter case, the diverting chamber can be referred to as fluid inlet or outlet collection chamber.

In a variant, one or more reinforcing elements 27 can be formed on at least one of the channels 13, notably on a nonlinear portion of this channel.

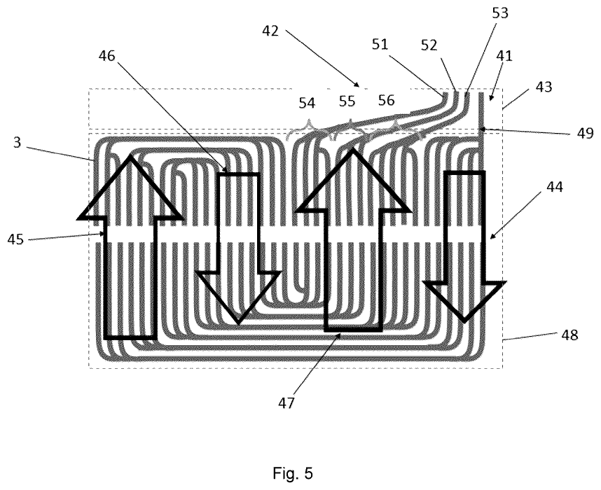

A temperature regulation device 40 according to another example of the invention has been described with reference to FIGS. 4 and 5.

This temperature regulation device 40, like that described above, has an upper plate 11, a lower plate 12 joined to the upper plate 11 such that the plates together form a plurality of circulation channels 13 for a heat transfer fluid, which is a fluid selected from the following refrigerant fluids R134a, R1234yf and R744.

This temperature regulation device 40 comprises a fluid inlet zone 41 and a fluid outlet zone 42.

This inlet zone 41 and this outlet zone 42 are located in a thermally inoperative region 43 illustrated in FIG. 5, this region 43 not facing the one or more components to be cooled.

The plurality of fluid circulation channels 3 successively comprise four groups 44, 45, 46 and 47 of channels 3, referred to as pass channels, each forming a fluid pass in a thermally operative region 48, which region 48 faces the one or more components to be cooled.

The channels 3, irrespective of the pass in question, all have the same fluid passage cross section over the majority of their length.

The plurality of channels 3 includes an inlet channel 49 connecting the fluid inlet zone 41 to the group of channels 3 forming the first pass 44.

The plurality of channels 3 also includes three outlet channels 3 connecting the group of channels 3 of the last pass 47 to the fluid outlet zone 42.

The channels 3 of the pass 47 are subdivided into three subgroups 54, 55 and 56 of channels 3, which is the same number as there are outlet channels 51, 52 and 53.

The channels 3 of each subgroup 54, 55 and 56 join the outlet channel 51, 52, 53 associated to it.

The number of channels 3 in the subgroups 54, 55 and 56 are different.

In the example described, the pass group 44 directly connected to the inlet channel 49 is adjacent to the subgroup 56 of the last pass 47.

This subgroup 56 of the pass 47 has a number of channels 3, in this case this number of channels 3 being equal to five, which is the highest among the subgroups 54, 55 and 56 of this pass 47.

The number of channels 3 in the outer subgroups 54 and 56 is higher than the number of channels 3 of the subgroup 55 located in between the two outer subgroups 54 and 56.

For example, the number of channels 3 of the outer subgroup 56 is five, and the number of channels 3 of the outer subgroup 54 is four.

The number of channels 3 of the subgroup 55 in between them is three.

The numbers of channels 3 in the outer subgroups 54 and 56 are different, specifically one being five and the other being four.

The group 44 of channels 3 connected to the inlet channel 49 has more than two channels 3, in this case two subgroups 58 of three channels 3 each.

The channels 3 in each group or pass 44, 45, 46 and 47 are mutually parallel over the majority of their length.

These channels 3 are substantially rectilinear over the majority of their length.

The number of channels 3 increases from one pass to the next 44, 45, 46 and 47, in the direction from the fluid inlet to the fluid outlet, with potentially a number of passes which remains constant over two passes or more.

The pass 44 has 2 subgroups of 3 channels 3 each.

The pass 45 has 3 subgroups of 3 channels 3 each.

The pass 46 has 3 subgroups of 3 channels 3 each.

The pass 47 was already described above.

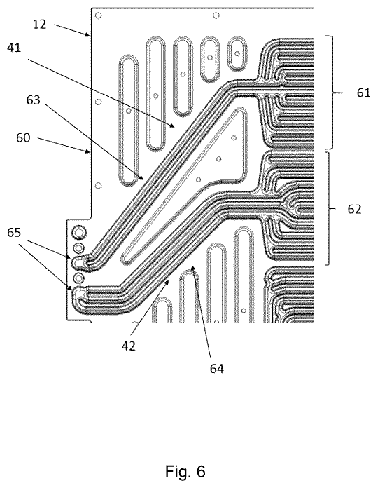

A detail of a temperature regulation device 60 according to another example of implementation of the invention has been illustrated in FIG. 6.

As for the preceding example, this temperature regulation device 60 comprises a fluid inlet zone 41 and a fluid outlet zone 42.

As can be seen, the first pass 61 is formed by a group of ten channels 3 in total, distributed in two subgroups.

The second pass 62 is formed by a group of eleven channels 3 in total, distributed in three subgroups.

Of course, the numbers of channels 3 and subgroups can vary depending on the cooling needs, whilst still ensuring satisfactory thermal homogeneity.

The lower plate 12 is visible in this Fig. and has stamped zones, which form the channels 3.

The inlet channel 63 and outlet channel 64 extend to the fluid inlet and outlet orifices 65. These fluid inlet and outlet orifices 65 are arranged to make it possible to connect the temperature regulation device 60 to a fluid circuit, which can for example comprise one or more heat exchangers and a compressor.

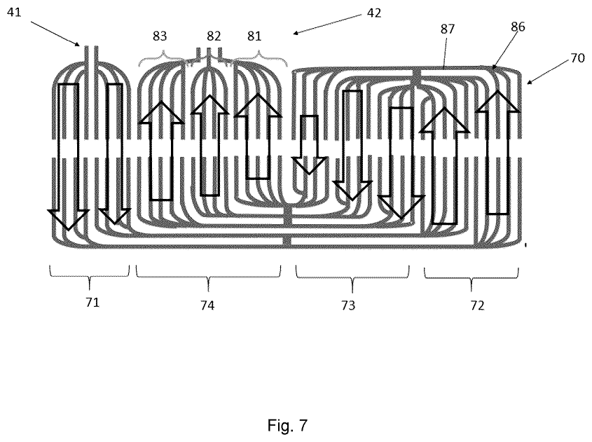

FIG. 7 shows a temperature regulation device 70 according to another example of the invention.

Like the preceding examples, this temperature regulation device 70 has a fluid inlet zone 41 and an outlet zone 42.

The channels 3 successively define 4 passes 71, 72, 73 and 74.

The first pass 71 is connected to the fluid inlet, and the fourth and last pass 74 is connected to the fluid outlet zone.

The passes 71 and 74 are adjacent.

In the example described, the first pass 71 is composed of 8 channels 3 in total.

The second pass 72 comprises 10 channels 3 in total.

The third pass 73 comprises 12 channels 3 in total.

The last pass 74 comprises 14 channels 3 in total that are disposed in three subgroups 81, 82 and 83, which have 5, 4 and 5 channels 3, respectively.

The subgroup 83, which is adjacent to the first pass 71, has the highest number of channels 3 among the three subgroups.

For example, two channels 3 can be joined at a node 86 to form a common channel 87, and the common channel joins another common channel coming from a node at which two or more other channels 3 join.

For example, a branching can correspond to the following case. In a zone for distributing the flow, the flow is divided into two channels 3 following a node. Then, these two channels 3 are also divided into two to supply other channels 3.

As can be seen in the examples described above, the number of channels 3 and their distribution into subgroups can vary depending on requirements. It is important that the number of channels 3 in the last pass is high enough to ensure good thermal homogeneity.

In addition, a high number of channels 3 makes it possible for them to have a relatively small passage cross section, thus limiting the pressure drops.

The invention also makes it possible to have standard channels 3 and the thermal needs are met by varying the number of them and the pattern in which they are laid out.

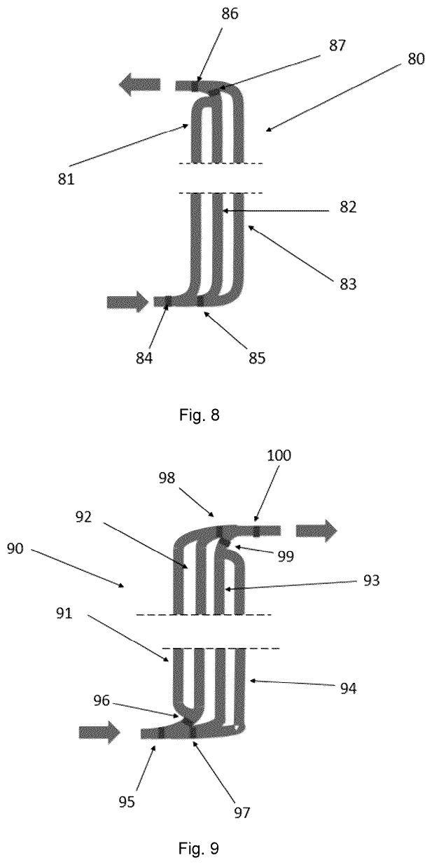

FIG. 8 illustrates, for at least one of the passes, the channels 3 of this pass which are disposed in a branching organization with nodes where at least two channels 3 of the pass are connected either, in the case of a distribution node, to distribute the fluid from one channel into two or more channels 3, or, for a collection node, to collect the fluid from two or more channels 3 into a collection channel, these nodes being disposed so as to make it possible to balance the pressure.

The total number of distribution nodes 84 and collection nodes 87 is the same for all the channels 3 of the pass.

More specifically, in the example of FIG. 8, the pass 80 has a branched organization with two distribution nodes 84 and two collection nodes 87, and the channel 81 first of all splits off from the collective channel via the distribution node 84, leaving the other two channels 82 and 83 to be distributed further downstream via the distribution node 85; downstream of the distribution node 84, this channel 81 joins the channel 82 via the collection node 87, which is upstream of the other collection node 86, which node 86 collects the already-together channels 81 and 82 with the channel 83.

In other words, the channel 81 is split off first for the distribution of fluid, before the channels 82 and 82. When a channel is split off first in the distribution zone, for example the channel 81, it should then rejoin last in the collection zone.

In this way, the invention makes it possible to balance the pressure losses and thus to homogenize the flow rates.

In another example illustrated in FIG. 9, for the pass 90, in the zone for distributing the flow, the flow is divided into two channels after the node 95. Then, these two channels are themselves divided into two, at the distribution nodes 96 and 97, respectively to supply the channels 91 and 92 following the distribution node 96, and the channels 93 and 94 following the node 97. In the collection zone, the nodes are symmetrical to those in the distribution zone. As a result, the channels 91 and 92 converge in one channel via the collection node 98, and the channels 93 and 94 converge in a second channel via the collection node 99. Then, these two channels join at the node 100.

What is claimed is:

1. A temperature regulation device comprising:
an upper plate and a lower plate joined together to form a plurality of circulation channels for a heat transfer fluid;
a fluid inlet zone and a fluid outlet zone;
the plurality of fluid circulation channels including:
at least two groups of pass channels each forming at least one fluid pass in a thermally operative region;
at least one inlet channel, connecting the fluid inlet zone and one of the at least two groups of pass channels;
at least two outlet channels, connecting another one of the at least two groups of pass channels to the fluid outlet zone, with pass channels thereof being subdivided into as many subgroups as there are outlet channels, each subgroup of pass channels being connected to the respective outlet channel.

2. The temperature regulation device as claimed in claim 1, wherein the number of inlet channels is smaller than the number of outlet channels.

3. The temperature regulation device as claimed in claim 1, wherein the number of outlet channels is between 2 and 6.

4. The temperature regulation device as claimed in claim 1, wherein the pass group of pass channels directly connected to the at least one inlet channel is adjacent to one of the subgroups of the group of pass channels connected to the one of the at least two outlet channels, this subgroup said subgroup having the highest number of pass channels among any other subgroups connected to any of the at least two outlet channels.

5. (canceled)

6. The temperature regulation device as claimed in claim 1, wherein the group of pass channels connected to the at least two outlet channels is subdivided into at least three subgroups, the number of pass channels in two outer subgroups is higher than the number of pass channels of any subgroup in between the two outer subgroups.

7. The temperature regulation device as claimed in claim 6, wherein the number of pass channels of the two outer subgroups includes one more than the number of pass channels of any subgroup in between the two outer subgroups.

8. The temperature regulation device as claimed in claim 6, wherein the numbers of pass channels in the two outer subgroups are different.

9. The temperature regulation device as claimed in claim 1, wherein the group of pass channels connected to the at least one inlet channel has more than 2 pass channels.

10. The temperature regulation device as claimed in claim 1, wherein the pass channels in each group of pass channels are mutually parallel over the majority of their length.

11. The temperature regulation device as claimed in claim 1, wherein the pass channels are substantially rectilinear over the majority of their length.

12. The temperature regulation device as claimed in claim 1, wherein the at least two groups of pass channels form a plurality of fluid passes and have numbers of pass channels which differ from one fluid pass to another.

13. The temperature regulation device as claimed in claim 1, wherein, in at least one of the fluid passes, the pass channels are disposed in a branching organization with at least one distribution node and at least one collection node where at least two pass channels are connected either, in case of the distribution nodes, to distribute the heat transfer fluid from one pass channel to two or more pass channels, or, for the collection node, to collect the heat transfer fluid from two or more pass channels into one pass channel.

14. The temperature regulation device as claimed in claim 13, wherein, in the at least one of the fluid passes, the total number of distribution nodes and collection nodes is the same for all the pass channels.

15. A system comprising:
an electrical component; and
a temperature regulation device including:
an upper plate and a lower plate joined together to form a plurality of circulation channels for a heat transfer fluid;
a fluid inlet zone and a fluid outlet zone;
the plurality of fluid circulation channels including:
at least two groups of pass channels each forming at least one fluid pass in a thermally operative region;
at least one inlet channel, connecting the fluid inlet zone and one of the at least two groups of pass channels;
at least two outlet channels, connecting another one of the at least two groups of pass channels to the fluid outlet zone, with pass channels being subdivided into as many subgroups as there are outlet channels, each subgroup of pass channels being connected to the respective outlet channel;
the electrical component being in thermal contact with the upper plate of the temperature regulation device.
